(19) United States
(12) Patent Application Publication
(10) Pub. No.: US 2024/0015372 A1
(43) Pub. Date: Jan. 11, 2024

(54) VIDEO SUMMARIZATION METHOD AND APPARATUS

(71) Applicant: SAMSUNG ELECTRONICS CO., LTD., Suwon-si (KR)

(72) Inventors: Lanlin TANG, Nanjing (CN); Jiang Yu, Nanjing (CN); Lingling GE, Nanjing (CN); Lin DING, Nanjing (CN)

(73) Assignee: SAMSUNG ELECTRONICS CO., LTD., Suwon-si (KR)

(21) Appl. No.: 18/218,442

(22) Filed: Jul. 5, 2023

(30) Foreign Application Priority Data
Jul. 5, 2022 (CN) 202210790685.9

(51) Int. Cl. H04N 21/8549; H04N 21/234; G06V 40/20

(52) U.S. Cl. CPC H04N 21/8549; H04N 21/23424; G06V 40/20

(57) ABSTRACT

A video summarization method that includes: obtaining an attention coding parameter of a user based on behavior data of the user; determining, for each clip included in a target video, whether the clip is a clip of interest to the user, based on the attention coding parameter of the user; based on determining that at least one clip included in the target video is a clip of interest, identifying, for each clip of interest included in the target video, at least one interest frame from the clip of interest; and obtaining a video summary of the target video by combining the interest frame from each clip of interest.

### CROSS-REFERENCE TO RELATED APPLICATION

This application is based on and claims priority under 35 U.S.C. § 119(a) to Chinese Patent Application No. CN202210790685.9, which was filed on Jul. 5, 2022, in the Chinese Intellectual Property Office (CNIPA), the disclosure of which is incorporated herein by reference in its entirety.

### BACKGROUND

### 1. Field

The disclosure relates to a computer vision technology, and more specifically, to a video summarization method and apparatus.

### 2. Description of Related Art

Many video platforms provide users with a variety of video-related services, such as video viewing services, video uploading services, and paid video services.

In order to improve the video viewing rate in the face of a large amount of video data and lengthy video content, a video producer and a video platform usually clip a video, and obtain (or extract) a portion of frames from the video to synthesize a new video (e.g., a video summary) to assist a user in quickly browsing and understanding the content.

Video summarization schemes in the related art have the problems of low efficiency, high cost, poor effect of improving the video viewing rate, etc. For example, a video summarization scheme in the related art may include manually browsing a video, and combining frames containing important information to obtain a video summary. Thus, a large amount of videos need to be manually browsed, resulting in high cost and low efficiency in video summarization.

Additionally, manual extraction of video key frames or key clips is based on preset rules (e.g., screen changes, audio changes, matching predefined screen tags, etc.). The preset rules generally cater to the most common preferences of users. However, in practical application, different users may have different preferences, and accordingly, different users may prefer different video contents in the same video. As a result, the obtained video key frames or key clips do not match the interests of every user. Therefore contents in the video that are of interest to some of the users may not be presented in the video summary. Thus, these users will not be effectively attracted to view this video, resulting in the video viewing rate not being be effectively improved.

### SUMMARY

Provided is a video summarization method and apparatus that may improve an efficiency of video summarization, reduce an application cost, and advantageously improve a video viewing rate.

According to an aspect of the disclosure a video summarization method includes: obtaining an attention coding parameter of a user based on behavior data of the user; determining, for each clip included in a target video, whether the clip is a clip of interest to the user, based on the attention coding parameter of the user; based on determining that at least one clip included in the target video is a clip of interest, identifying, for each clip of interest included in the target video, at least one interest frame from the clip of interest; and obtaining a video summary of the target video by combining the interest frame from each clip of interest.

The behavior data may include input-related information and a viewing behavior record of the user within a statistical window, the input-related information including at least one of input content information, a time when an input operation is performed, or a place where the input operation is performed.

The obtaining the attention coding parameter of the user may include: obtaining a vector representation of the behavior data by coding the behavior data; and obtaining the attention coding parameter of the user by inputting the vector representation into a preset first self-attention calculation model to perform self-attention processing.

The determining, for each clip included in the target video, whether the clip is a clip of interest may include: obtaining video frame vector representations of each video frame in the clip by coding each video frame in the clip; and determining whether the clip is a clip of interest based on the video frame vector representations.

The determining, for each clip included in the target video, whether the clip is a clip of interest may include: inputting the video frame vector representations into a preset second self-attention calculation model to perform self-attention processing, obtaining attention information for the clip; and determining whether the clip is of a clip interest based on the attention information.

The determining, for each clip included in the target video, whether the clip is a clip of interest may include: obtaining a matching value between the clip and the user by matching the attention information corresponding to the clip with the attention coding parameter of the user; and determining whether the clip is a clip of interest based on the matching value.

The identifying, for each clip of interest included in the target video, the at least one interest frame from the clip of interest may include: identifying the at least one interest frame from a plurality of video frames in the clip.

The identifying, for each clip of interest included in the target video, the at least one interest frame from the clip of interest may include: obtaining the attention information corresponding to each video frame from the plurality of video frames in the clip; and identifying the at least one interest frame based on the attention information corresponding to each video frame.

The identifying, for each clip of interest included in the target video, the at least one interest frame from the clip of interest may include: obtaining an inter-frame weight of a first frame based on the attention information corresponding to each video frame, during the self-attention processing; and based on the inter-frame weight of the first frame being greater than a preset interest threshold, identifying the first frame as an interest frame.

The obtaining the video summary of the target video based on combining the interest frame from each clip of interest may include: based on a clip of interest being a first interest clip in the target video, combining the at least one interest frame in the first interest clip in chronological order; and obtaining a current video summary of the target video based on a result of combining the at least one interest frame in the first interest clip.

The obtaining the video summary of the target video may include: based on a clip of interest not being the first interest clip in the target video, inputting the at least one interest frame in the clip of interest, the current video summary, and a corresponding summary duration into a preset third self-attention calculation model to perform self-attention processing, obtaining a relationship type between the at least one interest frame in the clip of interest and each video frame in the current video summary, through the preset third self-attention calculation model; and combining the at least one interest frame in the clip of interest and the current video summary based on the relationship type.

The obtaining the video summary of the target video may include: based on the clip of interest not being a last interest clip in the target video, updating the current video summary based on a result of combining the at least one interest frame in the clip of interest and the current video summary.

The obtaining the video summary of the target video may include: based on the clip of interest being a last interest clip in the target video, updating the current video summary based on a result of combining the at least one interest frame in the clip of interest and the current video summary; and obtaining the video summary of the target video based on the updated current video summary.

The relationship type may include at least one of appended frames, replaced frames, fused frames, or dropped frames.

According to an aspect of the disclosure a video summarization apparatus includes: a user attention parameter generation unit; an interest frame extraction unit; a combining unit; a memory storing at least one instruction; and at least one processor configured to execute the at least one instruction to: obtain, through the user attention parameter generation unit, an attention coding parameter of a user based on behavior data of the user; determine, through the interest frame extraction unit, for each clip included in a target video, whether the clip is a clip of interest to the user, based on the attention coding parameter of the user; identify, through the interest frame extraction unit, at least one interest frame from at least one clip of interest included in the target video; and obtain, through the combining unit, a video summary of the target video by combining the at least one interest frame from the at least one clip of interest.

The at least one processor is further configured to execute the at least one instruction to: obtain a vector representation of the behavior data by coding the behavior data; and obtain the attention coding parameter of the user based on inputting the vector representation into a preset first self-attention calculation model to perform self-attention processing.

The at least one processor is further configured to execute the at least one instruction to: obtain video frame vector representations of each video frame in the clip by coding each video frame in the clip; and determine whether the clip is a clip of interest based on the video frame vector representations.

The at least one processor is further configured to execute the at least one instruction to: input the video frame vector representations into a preset second self-attention calculation model to perform self-attention processing, obtain attention information for the clip; and determine whether the clip is a clip of interest based on the attention information.

The at least one processor is further configured to execute the at least one instruction to: obtain a matching value between the clip and the user by matching the attention information corresponding to the clip with the attention coding parameter of the user; and determine whether the clip is of interest based on the matching value.

According to an aspect of the disclosure a non-transitory computer readable medium stores computer readable program code or instructions which are executable by a processor to perform a method for video summarization. The method includes: obtaining an attention coding parameter of a user based on behavior data of the user; determining, for each clip included in a target video, whether the clip is a clip of interest to the user, based on the attention coding parameter of the user; based on determining that at least one clip included in the target video is a clip of interest, identifying, for each clip of interest included in the target video, at least one interest frame from the clip of interest; and obtaining a video summary of the target video by combining the interest frame from each clip of interest.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic flowchart of a video summarization method according to an embodiment;

FIG. 2 is a schematic diagram of obtaining an attention coding parameter of a user according to an embodiment;

FIG. 3 is an example diagram of obtaining an attention coding parameter of a user according to an embodiment;

FIG. 4 is a schematic diagram of selecting an interest clip according to an embodiment;

FIG. 5 is a diagram of frame combining when an interest clip is not the first interest clip in a target video according to an embodiment;

FIG. 6 is a diagram of inputting an interest clip into a pre-trained attention calculation model for processing to obtain a corresponding attention matrix according to an embodiment;

FIG. 7 is an example diagram of an embodiment of the present invention in scenario 1.

FIG. 8 is an example diagram of an embodiment of the present invention in scenario 2. and

FIG. 9 is a schematic structural diagram of a video summarization apparatus according to an embodiment;

FIG. 10 is a schematic flowchart of a video summarization method according to an embodiment; and

FIG. 11 is a schematic structural diagram of a video summarization apparatus according to an embodiment.

### DETAILED DESCRIPTION

Hereinafter, embodiments of the present disclosure will be described in detail with reference to the accompanying drawings, where similar reference characters denote corresponding features consistently throughout.

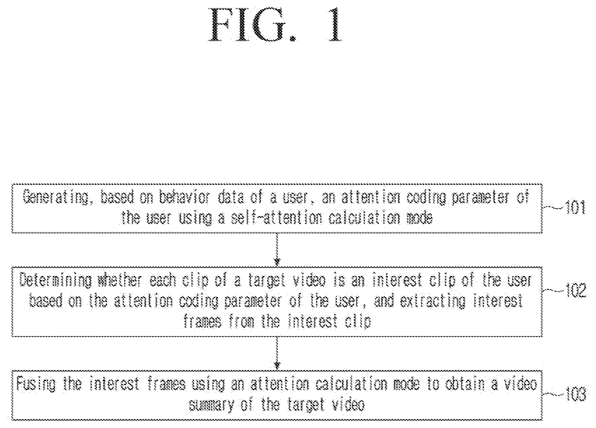

FIG. 1 is a schematic flowchart of a video summarization method according to an embodiment.

As shown in FIG. 1, at operation 101, based on behavior data of a user, an attention coding parameter (or attention parameter) of the user is obtained through a self-attention calculation mode. This operation is used to obtain an attention coding parameter capable of reflecting viewing preferences of a user based on behavior data of the user, so as to obtain (or extract), in subsequent operations, interest frames for obtaining a video summary from a target video based on the attention coding parameter of the user, whereby the video summary may fully represent the content of interest to the user maximally, thereby facilitating the user to accurately view a preferred video based on the video summary and further advantageously improving the video viewing rate.

In an embodiment, the behavior data may include input-related information and a viewing behavior record of the user within a statistical window.

The input-related information is information related to performing an information input operation by the user in a video platform, and may include, but is not limited to, input content information, a time when an input operation is performed, a place where the input operation is performed, and/or a device for performing the input operation, etc.

The viewing behavior record is a historical record about video viewing of the user on the video platform. The viewing behavior record is used to improve the accuracy of a self-attention calculation model used when performing self-attention calculation, and may include, but is not limited to, a video viewed by the user, a viewing duration, a viewing frequency, etc.

The statistical window is used to define a data time range for obtaining the attention coding parameter of the user, and those skilled in the art would have been able to specifically set a suitable value according to actual needs.

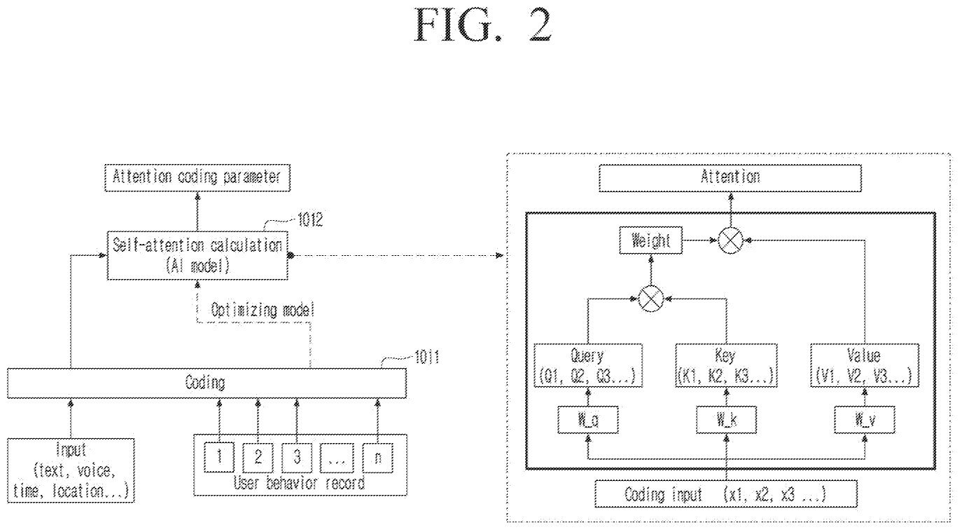

FIG. 2 is a schematic diagram of obtaining an attention coding parameter of a user according to an embodiment.

As shown in FIG. 2, the attention coding parameter of the user may be obtained by following operations 1011 and 1012.

In operation 1011, behavior data of the user is coded to obtain a vector representation of the behavior data.

Here, a vector representation of behavior data of a fixed dimension may be obtained by the coding.

The specific implementation of this operation is known to those skilled in the art, and the descriptions thereof are omitted herein.

In operation 1012, the vector representation is input into a preset first self-attention calculation model for processing, to obtain an attention coding parameter of the user.

In this operation, a pre-trained self-attention calculation model will be used to generate the attention coding parameter of the user based on the vector representation of the behavior data of the user obtained in operation 1011. The specific self-attention calculation processing method of the self-attention calculation model is as follows: a parameter matrix of the model obtains three tensors (Query, Key and Value). Query is multiplied by Key to obtain a similarity matrix (Weight). Weight is multiplied by Value to obtain the attention coding parameter of the user.

It should be noted that input data used for obtaining the attention coding parameter of the user herein is the behavior data of the user in the latest time period, and the behavior data is the latest behavior data of the user. Accordingly, the obtained attention coding parameter of the user based thereon may also reflect the latest viewing preference of the user. Therefore, the obtained attention coding parameter of the user can always match the dynamically changing viewing preference of the user.

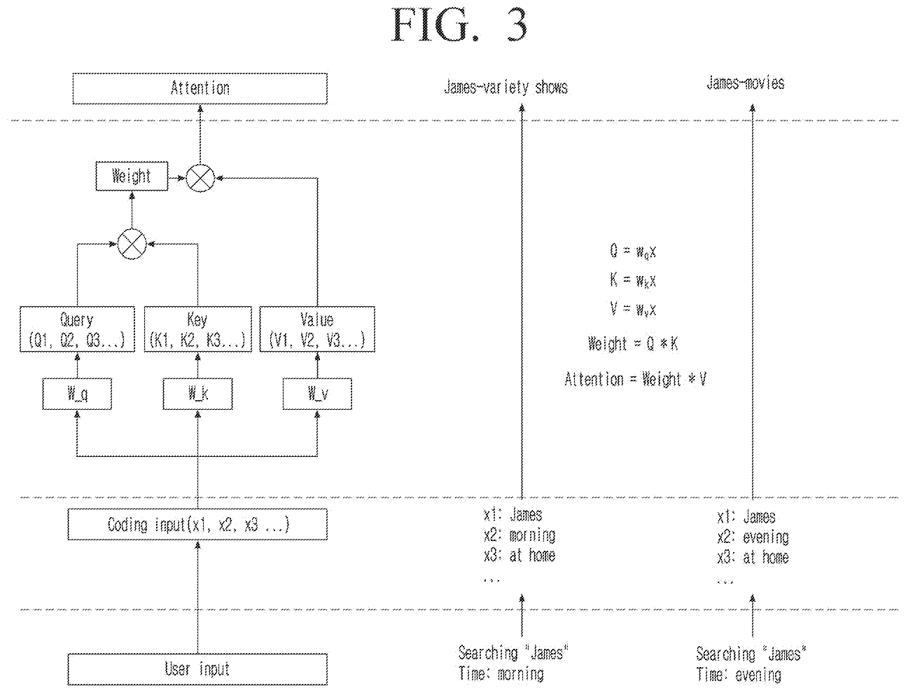

FIG. 3 is an example diagram of obtaining an attention coding parameter of a user according to an embodiment.

As shown in FIG. 3, when the same user inputs the same information at different times, the obtained attention coding parameters of the user will also be different. As shown, when a user searches for James in the morning, the obtained attention coding parameter of the user characterizes James-variety shows, and when the user searches for James in the evening, the obtained attention coding parameter of the user characterizes James-movies.

In operation 102 of FIG. 1, it is determined whether each clip of a target video is an interest clip of the user based on the attention coding parameter of the user, and interest frames are obtained from the interest clip.

Here, given that the shown video clip is associated with a user interest, the probability of selecting to view this video by the user is higher. To this end, in this operation, an interest clip of interest to the user is selected in a target video, and then a video frame of interest to the user is selected therefrom, whereby a video summary matching user preferences is obtained based on the selected video frame in subsequent operations.

In practical application, existing methods may be used to slice the target video into clips, and the descriptions thereof are omitted herein.

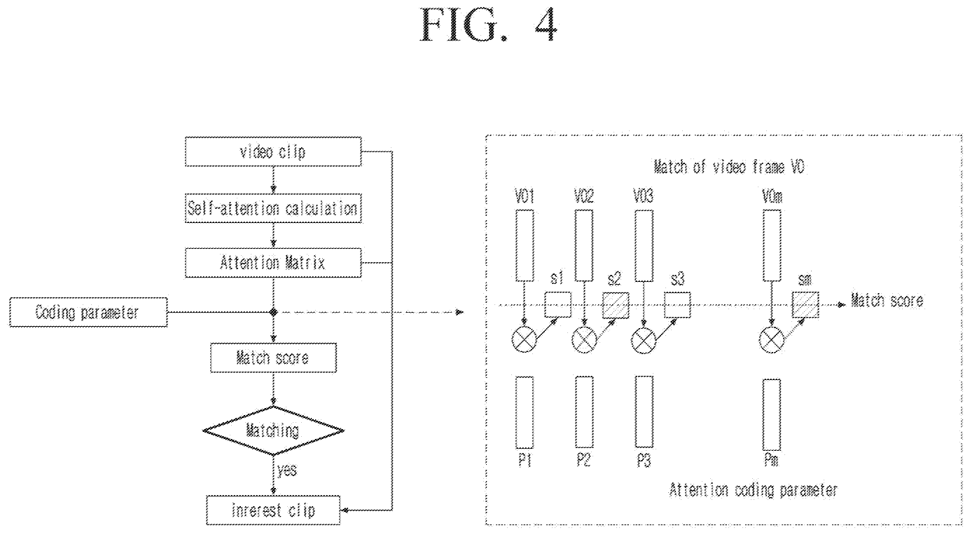

FIG. 4 is a schematic diagram of selecting an interest clip according to an embodiment.

As shown in FIG. 4, operation 102 of FIG. 1 may be specifically implemented by the following method.

Each video frame in each of the clips is coded, and all video frame vector representations obtained by coding are input into a preset second self-attention calculation model to perform self-attention processing, so as to obtain attention information of each video frame in the respective clip. All the attentions corresponding to the respective clip are matched with the attention coding parameter of the user to obtain a matching value between the respective clip and the user. It is determined whether the respective clip is an interest clip based on the matching value. If yes, based on an inter-frame weight corresponding to each of the attentions obtained during the self-attention processing, a frame with the inter-frame weight greater than a preset interest threshold is selected from the respective clip as an interest frame.

In the aforementioned method, each clip is coded in units of frames, and attention information of each video frame is calculated. The attention information of the video frame has the same dimension as the attention coding parameter of the user. The attention information of each video frame is matched with the attention coding parameter of the user respectively to obtain a matching value of the video frame. Then a matching value of the respective clip is obtained based on the matching values of all the video frames of the respective clip.

The aforementioned specific method for performing self-attention processing by the second self-attention calculation model is as follows: attention information of a video frame is obtained according to the following formula:

Q=wq·x

K=wk·x

V=wv·x

Weight=Q*K

Attention=Weight*V

where x represents a vector representation of a video frame, wq is an attention weight for Query of the second self-attention calculation model, wk is an attention weight for Key of the second self-attention calculation model, and wv is an attention weight for Value of the second self-attention calculation model. Weight is an inter-frame weight of a video attention, and a video frame with a great weight may be obtained as an interest frame based on the inter-frame weight. Attention is the attention information of the video frame.

The aforementioned interest threshold is used to obtain (or extract) a video frame of interest to the user, and those skilled in the art would have been able to specifically set a suitable value according to actual needs.

In practical application, in order to further improve processing efficiency, video clips may be processed in parallel in operation 102 of FIG. 1.

In operation 103 of FIG. 1, the interest frames are combined (or fused) through an attention calculation mode to obtain a video summary of the target video.

Here, since the video summary is obtained based on the interest frame obtained in operation 102 of FIG. 1, the obtained video summary can be matched with the viewing preferences of the user, thereby ensuring that the video summary maximally contains contents that may be of interest to the user. In this way, the user can accurately determine whether the user is interested in viewing the target video by viewing the video summary, so as to avoid the problem that the user misses to view the preferred target video because the contents of interest to the user in the target video are not represented in the video summary, thereby advantageously improving the video viewing rate.

In an embodiment, in operation 103 of FIG. 1, the interest frames may be combined by specifically using the following method:

Each interest clip Ci is traversed in turn, and combining (or fusing) is performed based on interest frames in the respective interest clip Ci.

It is necessary to distinguish whether the each interest clip Ci is the first interest clip, and different combining methods are used as follows.

If the respective interest clip Ci is the first interest clip in the target video, all interest frames in the interest clip Ci are spliced and combined in chronological order, and a splicing and combining result is taken as a current video summary.

If the interest clip Ci is not the first interest clip in the target video, the interest frames in the interest clip Ci, the current video summary and a corresponding summary duration are input into a preset third attention calculation model for processing to obtain a relationship type between each of the interest frames in the interest clip Ci and each video frame in the current video summary. Each of the interest frames in the interest clip Ci and the current video summary are spliced and combined based on the relationship type. If the interest clip Ci is a last interest clip in the target video, a current result of the splicing and combining is taken as a video summary of the target video, otherwise, the current video summary is updated to the current result of the splicing and combining.

In an embodiment, the relationship type includes appended frames, replaced frames, combined frames, and dropped frames.

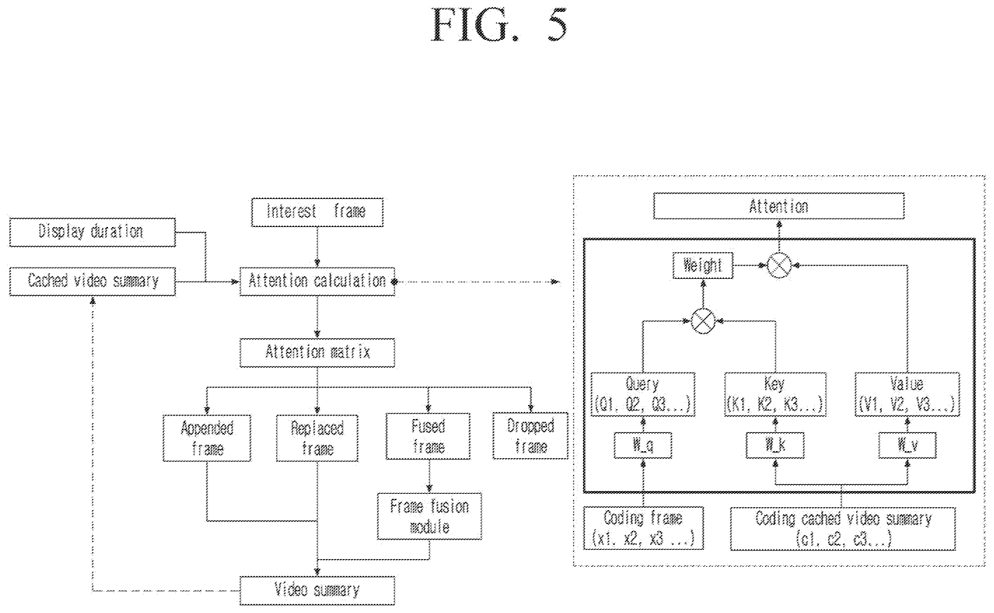

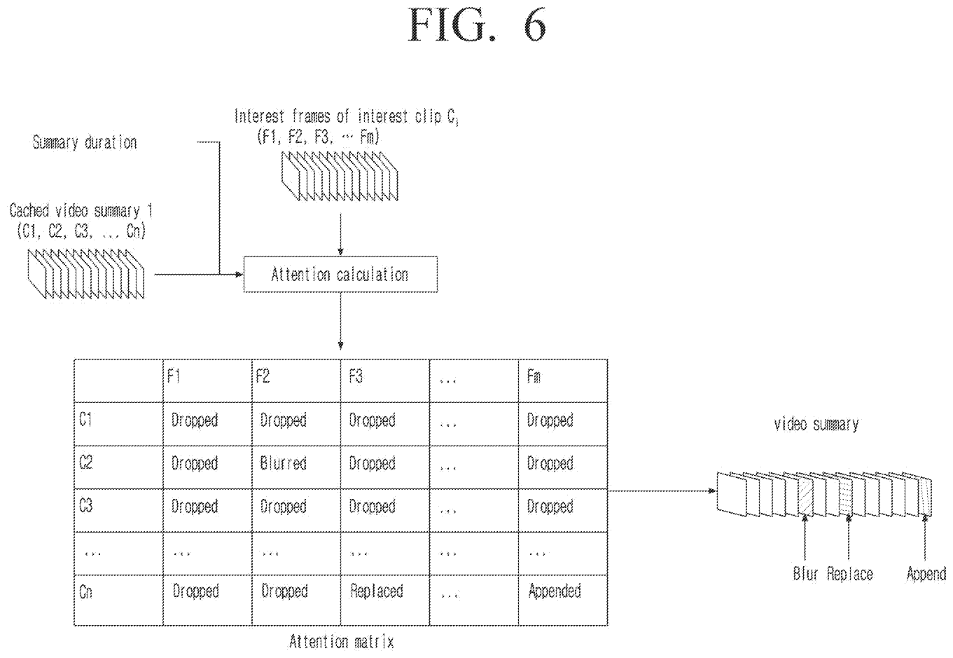

FIG. 5 is a diagram of frame combining when an interest clip is not the first interest clip in a target video according to an embodiment. FIG. 6 is a diagram of inputting an interest clip into a pre-trained attention calculation model for processing to obtain a corresponding attention matrix according to an embodiment.

FIG. 5 shows an example diagram of combining when an interest clip Ci is not the first interest clip in a target video. As shown in FIG. 5, after the interest clip Ci is input into the pre-trained third attention calculation model for processing, a corresponding attention matrix is obtained (as shown in the example of FIG. 6). Based on the attention matrix, relationship types between each of the interest frames in the interest clip Ci and each video frame in the current video summary may be obtained. Combining based on these relationship types can ensure a better combining effect. As shown in FIG. 6, when the interest frames in the interest clip Ci are combined with the currently obtained video summary, a better effect can be obtained by combining an interest frame F2 in the interest clip Ci with C2, a better effect can be obtained by replacing Cn with F3, and Fm should be appended behind Cn. When the relationship types are dropped frames, it means that they can be ignored.

Specifically, in the aforementioned method, inter-frame combining can be achieved using an existing method, and the descriptions thereof are omitted herein. In addition, in order to match a current playing scenario requirement, when obtaining the video summary of the target video, the size of the video summary may be set according to a showing size of a current scenario, so as to ensure that the video summary of the target video obtains a better showing effect in the current scenario.

It can be seen from the aforementioned method embodiments that with the aforementioned schemes, a personalized video summary may be automatically obtained, and the aforementioned schemes may adapt to different showing scenarios to automatically generate a short video consistent with the showing size and the showing time, thereby reducing the cost of processing a video by professionals, improving the efficiency of clip generation, and overcoming the limitation of video clipping with fixed parameters. With a personalized video summary, it is possible for users to screen out videos of interest to the users more efficiently, and a better user experience is provided when browsing TVs. For a video producer, obtaining respective preferred video summaries for users can improve the viewing rate of the users. Especially for paid videos, when clipped video previews have more contents associated with their interests, the probability of purchasing by the users will be higher. In addition, with the aforementioned schemes, user preferences obtained by the user based on accumulated operation records on a device are in a long-term state and are continuously optimized, and the obtained user interest points will be more accurate. In practical application, the aforementioned schemes can process any length of video, and can be triggered to be executed as needed by users and interrupted at any time as needed, and a video summary is output. In the aforementioned method, video clips may also be processed in parallel, thereby effectively improving the processing efficiency.

The specific implementation of the aforementioned schemes and methods is further described below in connection with two specific application examples.

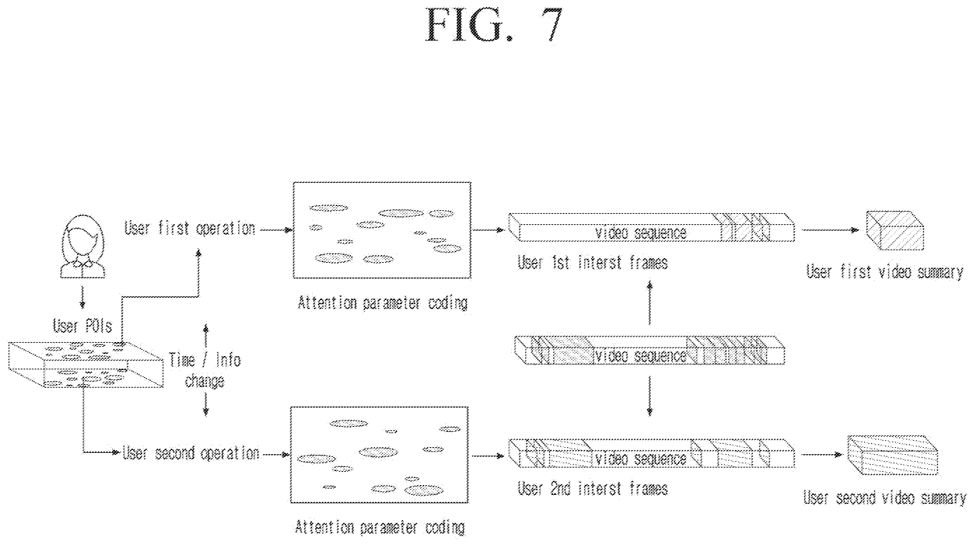

FIG. 7 is an example diagram of an embodiment of the present invention in scenario 1. As shown, a user will see different video summaries at the time of viewing a new online/pay-per-view movie.

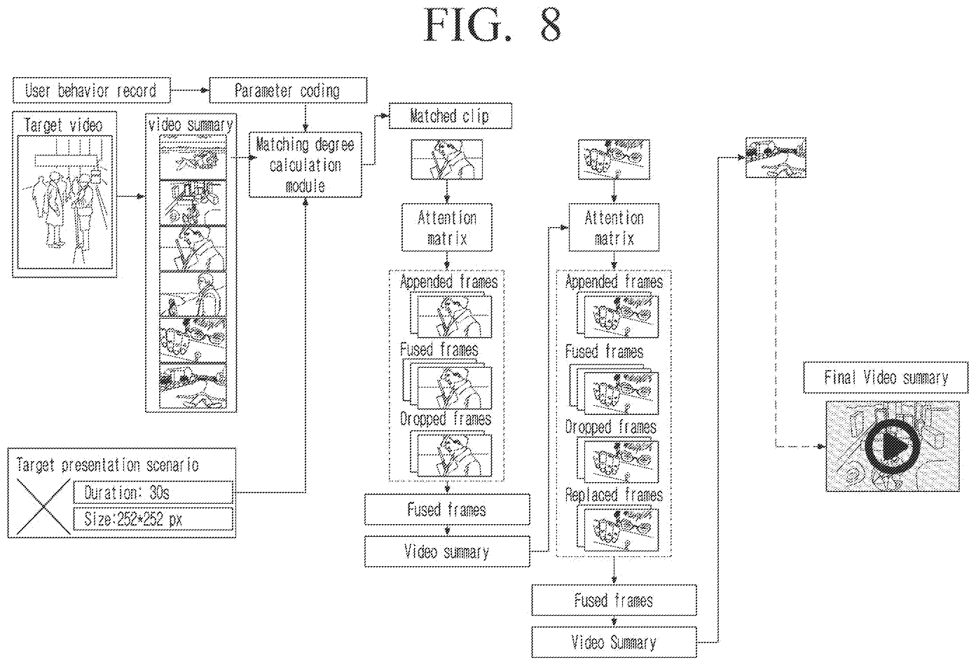

FIG. 8 is an example diagram of an embodiment of the present invention in scenario 2. As shown, with the aforementioned schemes, it is possible to obtain (or extract) a personalized video summary in a target video to a user.

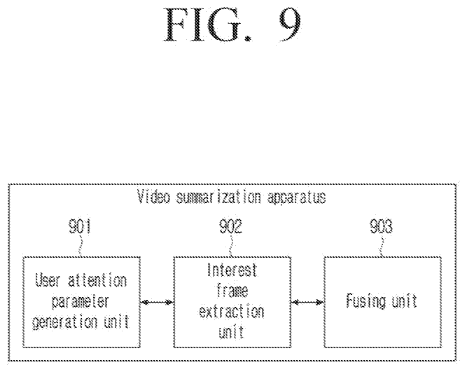

Based on the aforementioned method embodiments, embodiments of the present invention also propose a corresponding video summarization apparatus. FIG. 9 is a schematic structural diagram of a video summarization apparatus according to an embodiment. As shown in FIG. 9, the apparatus includes:

a user attention parameter generation unit 901, configured to generate, based on behavior data of a user, an attention coding parameter of the user through a self-attention calculation mode;

an interest frame extraction unit 902, configured to determine whether each clip of a target video is an interest clip of the user based on the attention coding parameter of the user, and obtain (or extract) interest frames from the interest clip; and

a combining unit 903, configured to combine the interest frames through an attention calculation mode to obtain a video summary of the target video.

It should be noted that the aforementioned method and apparatus are based on the same inventive concept. Since the principles of the method and apparatus for solving the problems are similar, the implementation of the apparatus and method may be referred to each other, and the repetition will be omitted.

Based on the aforementioned method embodiments, embodiments of the present invention also propose a video summarization device, including a processor and a memory. The memory has, stored therein, an application executable by the processor for causing the processor to perform the video summarization method as described above. Specifically, a system or apparatus equipped with a storage medium may be provided. A software program code that realizes the functions of any one implementation in the aforementioned embodiment is stored on the storage medium, and a computer (or a CPU or MPU) of the system or apparatus is caused to read out and execute the program code stored in the storage medium. Furthermore, some or all of actual operations may be performed by means of an operating system or the like operating on the computer through instructions based on the program code. The program code read out from the storage medium may also be written into a memory provided in an expansion board inserted into the computer or into a memory provided in an expansion unit connected to the computer. Then, the instructions based on the program code cause the CPU or the like installed on the expansion board or the expansion unit to perform some and all of the actual operations, thereby realizing the functions of any one of the aforementioned implementations of the video summarization method.

The memory may be specifically implemented as various storage media such as an electrically erasable programmable read-only memory (EEPROM), a flash memory and a programmable read-only memory (PROM). The processor may be implemented to include one or more central processing units or one or more field programmable gate arrays. The field programmable gate arrays integrate one or more central processing unit cores. Specifically, the central processing unit or central processing unit core may be implemented as a CPU or an MCU.

Embodiments of the present application implement a computer program product, including computer programs/instructions which, when executed by a processor, implement the operations of the video summarization method as described above.

It should be noted that not all the operations and modules in the aforementioned flowcharts and structural diagrams are necessary, and some operations or modules may be omitted according to actual requirements. The order of execution of the various operations is not fixed and may be adjusted as required. The division of the various modules is merely to facilitate the description of the functional division adopted. In actual implementation, one module may be implemented by a plurality of modules. The functions of the plurality of modules may also be realized by the same module. These modules may be located in the same device or in different devices.

Hardware modules in the various implementations may be implemented mechanically or electronically. For example, a hardware module may include a specially designed permanent circuit or logic device (e.g. a special purpose processor such as an FPGA or an ASIC) to complete a particular operation. The hardware module may also include a programmable logic device or circuit (e.g. including a general purpose processor or other programmable processors) temporarily configured by software to perform a particular operation. The implementation of the hardware modules mechanically, or through a special purpose permanent circuit, or through a temporarily configured circuit (e.g. configured by software) may be determined based on cost and time considerations.

As used herein, “schematic” means “serving as an instance, example, or illustration”, and any illustration and implementation described herein as “schematic” should not be construed as a more preferred or advantageous technical solution. For sake of clarity of the drawings, only portions of the various drawings related to the present invention are schematically shown and are not representative of an actual structure of the product. In addition, for sake of clarity of the drawings and ease of understanding, only one of members having the same structure or function may be schematically shown or marked in some of the drawings. As used herein, “one” does not mean to limit the number of related portions of the present invention to “only one”, and “one” does not mean to exclude the case that the number of related portions of the present invention is “more than one”. As used herein, “upper”, “lower”, “front”, “back”, “left”, “right”, “inner”, “outer”, etc. are used merely to indicate relative positional relationships between the related portions, and do not limit absolute positions of these related portions.

The above descriptions are preferred embodiments of the present invention and are not intended to limit the protection scope of the present invention. Any modification, equivalent replacement, improvement, etc. made within the spirit and principle of the present invention should be included within the protection scope of the present invention.

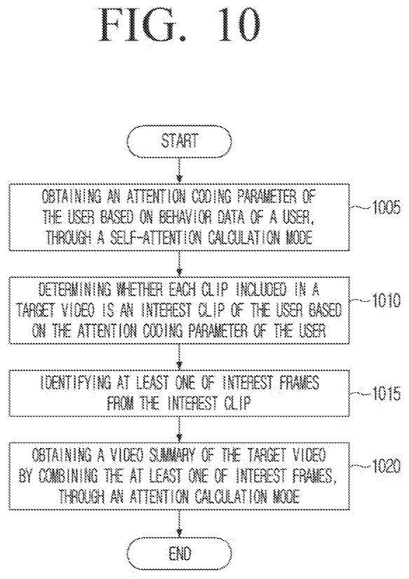

FIG. 10 is a schematic flowchart of a video summarization method according to an embodiment;

According to an aspect of the disclosure, a video summarization method may include obtaining an attention coding parameter of a user based on behavior data of the user (S1005), through a self-attention calculation mode, determining whether each clip included in a target video is an interest clip of the user based on the attention coding parameter of the user (S1010), identifying at least one of interest frames from the interest clip (S1015) and obtaining a video summary of the target video by combining (or fusing) the at least one of interest frames, through an attention calculation mode (S1020).

The method may include, obtaining a target video based on a user input. The user input may include command to generate the video summary corresponding to the target video. The method may include, based on the user input being received, performing the self-attention calculation mode. In the self-attention calculation mode, the method may include obtaining the behavior data of the user. The method may include obtaining the attention coding parameter based on the behavior data.

The method may include obtaining a plurality clips included in the target video. The method may include obtaining at least one of interest clip among the plurality clips included in the target video based on the attention coding parameter.

The attention coding parameter of the user may be described as an attention parameter, coding parameter, self-attention parameter, video summary parameter, video summarization parameter, image summarization parameter, feature extraction parameter or attention extraction parameter.

The method may use the attention coding parameter by determining whether each clip included in the target video is an interest clip of the user.

The behavior data may be described as behavior information or user behavior data.

The at least one of interest frames may be described as interest frame or at least one interest frame.

The method may include, after obtaining the interest clip (or the at least one of interest clip), obtaining a plurality of frames in the interest clip. The method may include obtaining the at least one of interest frames among the plurality of frames in the interest clip. According to various embodiments, the method may include obtaining the at least one of interest frames based on the attention coding parameter.

The method may include, after identifying all interest frames in the target video, changing the self-attention calculation mode to the attention calculation mode.

The self-attention calculation mode may described as a first mode or a first attention calculation mode. The attention calculation mode may described as a second mode or a second attention calculation mode.

The video summary of the target video may be described as a content summary, a summarized video, a summarized content or a summarized data.

The method may include combining (or fusing) the at least one of interest frames. The method may include, based on completion of identifying all interest frames in the target video, obtaining the video summary corresponding to the target video based on the combined result.

The combined result may include a plurality of results related with the combining operations.

The behavior data may include input-related information and a viewing behavior record of the user within a statistical window, the input-related information including input content information, a time when an input operation is performed and/or a place where the input operation is performed.

At least one of the input-related information or the viewing behavior record may obtain through a terminal device of the user.

The input-related information of the user may include at least one information corresponding user input. The terminal device may include a plurality of buttons. The method may include obtaining the input-related information through the terminal device. The method may include obtaining the input-related information corresponding to a button of the user input among the plurality of buttons.

The terminal device may include touch screen. The input-related information of the user may include touch position corresponding to the user input.

The statistical window may include a window for providing the target video.

The obtaining the attention coding parameter of the user may include obtaining a vector representation of the behavior data by coding the behavior data and obtaining the attention coding parameter of the user by inputting the vector representation into a preset first self-attention calculation model for performing self-attention processing.

The determining whether the each clip included in the target video is of interest to the user may include obtaining all video frame vector representations by coding each video frame in the each clip and determining whether the each clip is the interest clip based on the all video frame vector representations.

The determining whether the each clip included in the target video is the interest clip of the user may include inputting the all video frame vector representations into a preset second self-attention calculation model for performing self-attention processing, obtaining attention information in the each clip and determining whether the each clip is the interest clip based on the attention information.

The determining whether the each clip included in the target video is of interest to the user may include obtaining a matching value between the each clip and the user by matching the attention information corresponding to the each clip with the attention coding parameter of the user and determining whether the each clip is the interest clip based on the matching value.

The identifying the at least one of interest frames may include based on the each clip being the interest clip, identifying the at least one of interest frames among a plurality of video frames in the interest clip.

The identifying the at least one of interest frames may include obtaining the attention information corresponding to each video frame from the plurality of video frames in the interest clip and identifying the at least one of interest frames based on the attention information corresponding to the each video frame.

The identifying the at least one of interest frames may include obtaining an inter-frame weight of a first frame based on the attention information corresponding to the each video frame, during the self-attention processing and based on the inter-frame weight of the first frame being greater than a preset interest threshold, identifying the first frame as the at least one of interest frames.

The obtaining the video summary of the target video may include obtaining each interest clip Ci included in the target video, based on the interest clip Ci being a first interest clip in the target video, combining at least one of interest frames in the interest clip Ci in chronological order and obtaining a current video summary of the target video based on the combining result.

The obtaining the video summary of the target video may include based on the interest clip Ci not being a first interest clip in the target video, inputting at least one of interest frames in the interest clip Ci, the current video summary and a corresponding summary duration into a preset third self-attention calculation model for performing self-attention processing, obtaining a relationship type between each of the at least one of interest frames in the interest clip Ci and each video frame in the current video summary, through the preset third self-attention calculation model and combining the each of the at least one of interest frames in the interest clip Ci and the current video summary based on the relationship type.

The obtaining the video summary of the target video may include based on the interest clip Ci not being a last interest clip in the target video, updating the current video summary based on the combining result.

The obtaining the video summary of the target video may include based on the interest clip Ci being a last interest clip in the target video, updating the current video summary based on the combining result and obtaining the video summary of the target video based on the updated current video summary.

The relationship type may include at least one of appended frames, replaced frames, fused frames or dropped frames.

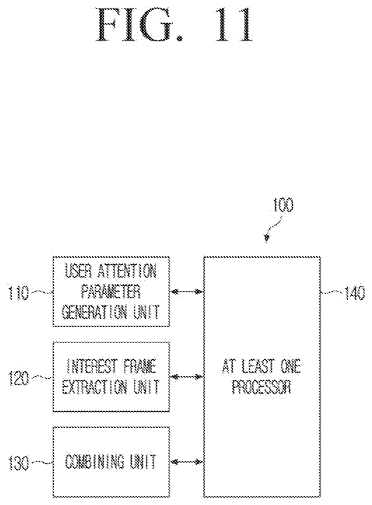

FIG. 11 is a schematic structural diagram of a video summarization apparatus according to an embodiment.

A video summarization apparatus 100 may include a user attention parameter generation unit 110, an interest frame extraction unit 120, a combining unit 130 and at least one processor 140. The user attention parameter generation unit 110, the interest frame extraction unit 120, and the combining unit 130 may be included in the at least one processor 140.

The at least one processor 140 may through the user attention parameter generation unit 110, obtain an attention coding parameter of the user based on behavior data of a user, through the interest frame extraction unit 120, determine whether each clip included in a target video is an interest clip of the user based on the attention coding parameter of the user, through the interest frame extraction unit 120, identify at least one of interest frames from the interest clip and through the combining unit 130, obtain a video summary of the target video by combine the at least one of interest frames.

The behavior data may include input-related information and a viewing behavior record of the user within a statistical window, the input-related information including input content information, a time when an input operation is performed and/or a place where the input operation is performed.

The at least one processor 140 may obtain a vector representation of the behavior data by coding the behavior data and obtain the attention coding parameter of the user by inputting the vector representation into a preset first self-attention calculation model for performing self-attention processing.

The at least one processor 140 may obtain all video frame vector representations by coding each video frame in the each clip and determine whether the each clip is the interest clip based on the all video frame vector representations.

The at least one processor 140 may input the all video frame vector representations into a preset second self-attention calculation model for performing self-attention processing, obtain attention information in the each clip and determine whether the each clip is the interest clip based on the attention information.

The at least one processor 140 may obtain a matching value between the each clip and the user by matching the attention information corresponding to the each clip with the attention coding parameter of the user and determine whether the each clip is the interest clip based on the matching value.

The at least one processor 140 may, based on the each clip being the interest clip, identify the at least one of interest frames among a plurality of video frames in the interest clip.

The at least one processor 140 may obtain the attention information corresponding to each video frame from the plurality of video frames in the interest clip and identify the at least one of interest frames based on the attention information corresponding to the each video frame.

The at least one processor 140 may obtain an inter-frame weight of a first frame based on the attention information corresponding to the each video frame, during the self-attention processing and, based on the inter-frame weight of the first frame being greater than a preset interest threshold, identify the first frame as the at least one of interest frames.

The at least one processor 140 may obtain each interest clip Ci included in the target video, based on the interest clip Ci being a first interest clip in the target video, combine at least one of interest frames in the interest clip Ci in chronological order and obtain a current video summary of the target video based on the combine result.

The at least one processor 140 may, based on the interest clip Ci not being a first interest clip in the target video, inputting at least one of interest frames in the interest clip Ci, the current video summary and a corresponding summary duration into a preset third self-attention calculation model for performing self-attention processing, obtain a relationship type between each of the at least one of interest frames in the interest clip Ci and each video frame in the current video summary, through the preset third self-attention calculation model and combine the each of the at least one of interest frames in the interest clip Ci and the current video summary based on the relationship type.

The at least one processor 140 may, based on the interest clip Ci not being a last interest clip in the target video, updating the current video summary based on the combine result.

The at least one processor 140 may, based on the interest clip Ci being a last interest clip in the target video, updating the current video summary based on the combine result and obtain the video summary of the target video based on the updated current video summary.

The relationship type may include at least one of appended frames, replaced frames, fused frames or dropped frames.

According to one or more example embodiments of the present disclosure, interest data capable of reflecting personality characteristics of users is obtained (or generated) based on behavior data of each user in consideration of personal viewing requirements of the users, and video clipping is performed based on the interest data of a respective user to obtain a video summary. Thus, by automatically obtaining (or generating) a video summary for a user based on the personality characteristics of the user, on the one hand, video content of interest to the user can be presented in the video summary shown to the user as much as possible, whereby the user can be most attracted to view the video, thereby effectively improving the video viewing rate; on the other hand, the problems of low efficiency and high cost of manually obtaining a video summary in the related art can be effectively solved.

While example embodiments of the disclosure have been shown and described, the disclosure is not limited to the aforementioned specific embodiments, and it is apparent that various modifications can be made by those having ordinary skill in the technical field to which the disclosure belongs, without departing from the gist of the disclosure as claimed by the appended claims and their equivalents. Also, it is intended that such modifications are not to be interpreted independently from the technical idea or prospect of the disclosure.

What is claimed is:

1. A video summarization method comprising:
obtaining an attention coding parameter of a user based on behavior data of the user;
determining, for each clip included in a target video, whether the clip is a clip of interest to the user, based on the attention coding parameter of the user;
based on determining that at least one clip included in the target video is a clip of interest, identifying, for each clip of interest included in the target video, at least one interest frame from the clip of interest; and
obtaining a video summary of the target video by combining the interest frame from each clip of interest.

2. The video summarization method of claim 1, wherein the behavior data comprises input-related information and a viewing behavior record of the user within a statistical window, the input-related information comprising at least one of input content information, a time when an input operation is performed, or a place where the input operation is performed.

3. The video summarization method of claim 1, wherein the obtaining the attention coding parameter of the user comprises:
obtaining a vector representation of the behavior data by coding the behavior data; and
obtaining the attention coding parameter of the user by inputting the vector representation into a preset first self-attention calculation model to perform self-attention processing.

4. The video summarization method of claim 1, wherein the determining, for each clip included in the target video, whether the clip is a clip of interest comprises:
obtaining video frame vector representations of each video frame in the clip by coding each video frame in the clip; and
determining whether the clip is a clip of interest based on the video frame vector representations.

5. The video summarization method of claim 4, wherein the determining, for each clip included in the target video, whether the clip is a clip of interest comprises:
inputting the video frame vector representations into a preset second self-attention calculation model to perform self-attention processing;
obtaining attention information for the clip; and
determining whether the clip is a clip of interest based on the attention information.

6. The video summarization method of claim 5, wherein the determining, for each clip included in the target video, whether the clip is a clip of interest comprises:
obtaining a matching value between the clip and the user by matching the attention information corresponding to the clip with the attention coding parameter of the user; and
determining whether the clip is a clip of interest based on the matching value.

7. The video summarization method of claim 6, wherein the identifying, for each clip of interest included in the target video, the at least one interest frame from the clip of interest comprises:
identifying the at least one interest frame from a plurality of video frames in the clip.

8. The video summarization method of claim 7, wherein the identifying, for each clip of interest included in the target video, the at least one interest frame from the clip of interest comprises:
obtaining the attention information corresponding to each video frame from the plurality of video frames in the clip; and
identifying the at least one interest frame based on the attention information corresponding to each video frame.

9. The video summarization method of claim 8, wherein the identifying, for each clip of interest included in the target video, the at least one interest frame from the clip of interest comprises:
obtaining an inter-frame weight of a first frame based on the attention information corresponding to each video frame, during the self-attention processing; and
based on the inter-frame weight of the first frame being greater than a preset interest threshold, identifying the first frame as an interest frame.

10. The video summarization method of claim 1, wherein the obtaining the video summary of the target video comprises:
based on a clip of interest being a first interest clip in the target video, combining the at least one interest frame in the first interest clip in chronological order; and
obtaining a current video summary of the target video based on a result of combining the at least one interest frame in the first interest clip.

11. The video summarization method of claim 10, wherein the obtaining the video summary of the target video comprises:
based on a clip of interest not being the first interest clip in the target video, inputting the at least one interest frame in the clip of interest, the current video summary, and a corresponding summary duration into a preset third self-attention calculation model to perform self-attention processing,
obtaining a relationship type between the at least one interest frame in the clip of interest and each video frame in the current video summary, through the preset third self-attention calculation model; and
combining the at least one interest frame in the clip of interest and the current video summary based on the relationship type.

12. The video summarization method of claim 11, wherein the obtaining the video summary of the target video comprises:
based on the clip of interest not being a last interest clip in the target video, updating the current video summary based on a result of combining the at least one interest frame in the clip of interest and the current video summary.

13. The video summarization method of claim 11, wherein the obtaining the video summary of the target video comprises:
based on the clip of interest being a last interest clip in the target video, updating the current video summary based on a result of combining the at least one interest frame in the clip of interest and the current video summary; and
obtaining the video summary of the target video based on the updated current video summary.

14. The video summarization method of claim 11, wherein the relationship type comprises at least one of appended frames, replaced frames, fused frames, or dropped frames.

15. A video summarization apparatus comprising:
a user attention parameter generation unit;
an interest frame extraction unit;
a combining unit;
a memory storing at least one instruction; and
at least one processor configured to execute the at least one instruction to:
obtain, through the user attention parameter generation unit, an attention coding parameter of a user based on behavior data of the user;
determine, through the interest frame extraction unit, for each clip included in a target video, whether the clip is a clip of interest to the user, based on the attention coding parameter of the user;
identify, through the interest frame extraction unit, at least one interest frame from at least one clip of interest included in the target video; and
obtain, through the combining unit, a video summary of the target video by combining the at least one interest frame from the at least one clip of interest.

16. The video summarization apparatus of claim 15, wherein the at least one processor is further configured to execute the at least one instruction to:
obtain a vector representation of the behavior data by coding the behavior data; and
obtain the attention coding parameter of the user by inputting the vector representation into a preset first self-attention calculation model to perform self-attention processing.

17. The video summarization apparatus of claim 15, wherein the at least one processor is further configured to execute the at least one instruction to:
obtain video frame vector representations of each video frame in the clip by coding each video frame in the clip; and
determine whether the clip is of interest based on the video frame vector representations.

18. The video summarization apparatus of claim 17, wherein the at least one processor is further configured to execute the at least one instruction to:
input the video frame vector representations into a preset second self-attention calculation model to perform self-attention processing,
obtain attention information for the clip; and
determine whether the clip is a clip of interest based on the attention information.

19. The video summarization apparatus of claim 18, wherein the at least one processor is further configured to execute the at least one instruction to:
obtain a matching value between the clip and the user by matching the attention information corresponding to the clip with the attention coding parameter of the user; and
determine whether the clip is a clip of interest based on the matching value.

20. A non-transitory computer readable medium for storing computer readable program code or instructions which are executable by a processor to perform a method for video summarization, the method comprising:
obtaining an attention coding parameter of a user based on behavior data of the user;
determining, for each clip included in a target video, whether the clip is a clip of interest to the user, based on the attention coding parameter of the user;
based on determining that at least one clip included in the target video is a clip of interest, identifying, for each clip of interest included in the target video, at least one interest frame from the clip of interest; and
obtaining a video summary of the target video by combining the interest frame from each clip of interest.
